(19) United States
(12) Patent Application Publication
(10) Pub. No.: US 2006/0183882 A1
(43) Pub. Date: Aug. 17, 2006

(54) CONTINUOUS PROCESS FOR PREPARATION OF POLYETHER POLYOLS

(76) Inventors: Edward Michael Dexheimer, Grosse Ile, MI (US); Hans V. Schwarz, Overijse (BE); Andreas Brodhagen, Dannstadt-Schauernheim (DE)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/276,275

(22) Filed: Feb. 22, 2006

Related U.S. Application Data
(63) Continuation-in-part of application No. 10/832,910, filed on Apr. 27, 2004.
(63) Continuation-in-part of application No. 11/151,617, filed on Jun. 13, 2005.
(63) Continuation-in-part of application No. 11/151,618, filed on Jun. 13, 2005.
Application No. 11/151,618 is a division of application No. 10/037,958, filed on Dec. 21, 2001, now Pat. No. 6,777,533.

(51) Int. Cl. C08G 65/04

(52) U.S. Cl. 528/416

(57) ABSTRACT

A continuous process for preparation of a polyether polyol in a reactor includes introducing an initial starter/catalyst mixture into the reactor. The initial starter/catalyst mixture comprises an initial starter and a catalyst with the catalyst selected from aluminum phosphate catalysts and/or aluminum phosphonate catalysts and/or residues of these catalysts. In this continuous process, one or more alkylene oxide is continuously introduced into the reactor. Additional amounts of the catalyst and a continuous starter are also continuously introduced into the reactor. The polyether polyol prepared herein is continuously withdrawn from the reactor.

### RELATED APPLICATIONS

This application is a continuation-in-part of and claims the benefit of co-pending U.S. patent application Ser. No. 10/832,910 filed on Apr. 27, 2004, which is a divisional of U.S. patent application Ser. No. 10/037,958 filed Dec. 21, 2001; Ser. No. 11/151,617 filed on Jun. 13, 2005; and Ser. No. 11/151,618 filed on Jun. 13, 2005.

### FIELD OF THE INVENTION

The present invention generally relates to a process for preparation of polyether polyols. More specifically, the present invention relates to a continuous process for preparation of polyether polyols using aluminum phosphate catalysts and/or aluminum phosphonate catalysts.

### BACKGROUND OF THE INVENTION

Polyoxyalkylene polyether polyols, more simply referred to as polyether polyols, are well known compounds. In one exemplary application, these polyether polyols are utilized, in conjunction with a cross-linking agent, such as an organic isocyanate, to form or produce a variety of polyurethane products, foamed and non-foamed, i.e., elastomeric, such as polyurethane foams and polyurethane elastomers. Generally, these polyols are produced by polyoxyalkylation of an initiator molecule with an alkylene oxide such as ethylene oxide, propylene oxide, butylene oxides, or mixtures thereof. The initiator molecules contain alkylene oxide-reactive hydrogens like those found in hydroxyl groups and amine groups. This oxyalkylation is generally conducted in the presence of a catalyst.

The most common catalysts are basic metal catalysts such as sodium hydroxide, potassium hydroxide, or alkali metal alkoxides. One advantage of these basic metal catalysts is that they are inexpensive and readily available. Use of these basic metal catalysts, however, is associated with a range of problems. One of the major problems is that oxyalkylation with propylene oxide has associated with it a competing rearrangement of the propylene oxide into allyl alcohol, which continually introduces a monohydroxyl-functional molecule. This monohydroxyl-functional molecule is also capable of being oxyalkylated. In addition, it can act as a chain terminator during the reaction with isocyanates to produce the final polyurethane product. Thus, as the oxyalkylation reaction is continued more of this unwanted product, generally measured as the unsaturation content of the polyol, is formed. This leads to reduced functionality and a broadening of the molecular weight (measured as either Mₙ or M_{w}) distribution of the polyol. The amount of unsaturation content may approach 30 to 40 molar % with unsaturation levels of 0.090 meq KOH/g or higher.

In an attempt to reduce the unsaturation content of polyether polyols, a number of other catalysts have been developed. One such group of catalysts includes the hydroxides formed from rubidium, cesium, barium, and strontium. These catalysts also present a number of problems. The catalysts only slightly reduce the degree of unsaturation, are much more expensive, and some are toxic.

A further line of catalyst development for polyether polyol production focuses on double metal cyanide (DMC) catalysts. These catalysts are typically based on zinc hexacyanocobaltate. With the use of DMC catalysts, it is possible to achieve relatively low unsaturation content in the range of 0.003 to 0.010 meq KOH/g. While the DMC catalysts would seem to be highly beneficial they also are associated with a number of difficulties. As a first difficulty, there is a relatively high capital cost involved in scaling up of and utilization of DMC catalysts. The catalysts themselves have an extremely high cost compared to the basic metal catalysts. Further, when forming a polyether polyol using a DMC catalyst, there is a significant initial induction period, i.e., lag time, before the DMC catalyst begins to catalyze the reaction. It is not possible to add ethylene oxide onto growing polyol chains utilizing DMC catalysts. To add ethylene oxide to a growing chain, the DMC catalysts must be replaced with the typical basic metal catalysts, thus adding complexity and steps. In addition, it is generally believed that the DMC catalysts should be removed prior to work-up of any polyether polyol for use in forming polyurethane products. Finally, polyether polyols generated using DMC catalysts are not mere “drop in” replacements for similar size and functionality polyols produced using the typical basic metal catalysts. Indeed, it has been found that often DMC catalyzed polyether polyols have properties very different from equivalent polyether polyols produced using, for example, potassium hydroxide.

The difficulties associated with use of DMC catalysts as described above exist whether the polyether polyol that is being produced is produced by batch synthesis or by continuous synthesis and further difficulties are inherent in both the batch and continuous syntheses. In a typical batch synthesis for producing a polyether polyol, the initiator molecule and the DMC catalyst are charged into a reactor and then the alkylene oxide is fed into the reactor. In this batch synthesis, the initiator molecule has a tendency to ‘quench’ the DMC catalyst thereby rendering the DMC catalyst inactive and unable to catalyze the remainder of the synthesis. As such, to effectively use DMC catalysts in batch synthesis of a polyether polyol, the initiator molecule must first be worked up, i.e., modified, to increase its molecular weight (measured as either Mₙ or M_{w}). This modification of the original initiator molecule is time consuming and typically requires a different catalysis mechanism as well as a separate, dedicated reactor which is undesirable.

As alluded to above, a polyether polyol may also be synthesized continuously using a DMC catalyst. Examples of this continuous synthesis are disclosed in U.S. Pat. No. 5,689,012 to Pazos et al. and U.S. Pat. No. 5,777,177 to Pazos. While the '012 and '177 patents disclose continuous synthesis, the polyether polyols prepared in the '012 and '177 patents are prepared strictly with DMC catalysts and, as already described above, there are difficulties that persist with use of the DMC catalysts and also with the polyether polyols that have been prepared in the presence of such catalysts. A further issue associated with the polyether polyols prepared in the '012 and '177 patents is that the resulting polyether polyols include high molecular weight poly-propylene oxide, also commonly referred to as a high molecular weight ‘tail’, which is undesirable.

Thus, there exists a need for a unique process for preparation of polyether polyols that can be practiced in existing systems and equipment using standard manufacturing conditions and that does not rely on DMC catalysts yet still produces very low unsaturation polyether polyols with the same or better properties than those of polyether polyols produced using basic metal catalysts.

### SUMMARY OF THE INVENTION AND ADVANTAGES

A continuous process for preparation of a polyether polyol is disclosed. The continuous process prepares the polyether polyol in a reactor and includes introducing an initial starter/catalyst mixture into the reactor. The initial starter/catalyst mixture comprises an initial starter and a catalyst. The catalyst is selected from aluminum phosphate catalysts and/or aluminum phosphonate catalysts and/or residues of the aluminum phosphate catalysts and aluminum phosphonate catalyst. One or more alkylene oxide is continuously introduced into the reactor as are additional amounts of the catalyst. The process further includes continuously introducing a continuous starter into the reactor. The continuous starter and the initial starter may be the same or different. The polyether polyol is continuously withdrawn from the reactor.

Through use of the aluminum phosphate catalysts and/or the aluminum phosphonate catalysts, the continuous process of the present invention does not rely on DMC catalysts. Because these aluminum-based catalysts are less expensive than the DMC catalysts, the continuous process of the present invention, which uses these aluminum-based catalysts, is less expensive than continuous processes that use the DMC catalysts. This process can be practiced in existing systems and equipment using standard manufacturing conditions. Furthermore, this process produces very low unsaturation (e.g. less than 0.080 meq KOH/g such as less than or equal to 0.020 meq KOH/g) polyether polyols with the same or better properties than those of polyether polyols produced using basic metal catalysts and DMC catalysts. The polyether polyols prepared according to the process of the subject invention have no measurable amount of the high molecular weight (measured as either Mₙ or M_{w}) tail typically associated with the polyether polyols produced by conventional processes utilizing DMC catalysts. The polyether polyols prepared according to this inventive process also have narrower molecular weight distributions (also commonly referred to as polydispersity) as compared to the conventional polyether polyols.

### DETAILED DESCRIPTION

A polyether polyol, i.e., a polyoxyalkylene polyether polyol or a polyetherol, and a process for preparation of the polyether polyol in a reactor are disclosed. More specifically, the process is a continuous process and the reactor is preferably a continuous reactor, most preferably a tubular reactor or a continuous stirred tank reactor (CSTR). Generally, the process uses aluminum-based catalysts, such as aluminum phosphate catalysts and/or aluminum phosphonate catalysts, to prepare, i.e., produce or form, the polyether polyol. In the context of the present invention, ‘aluminum-based’ catalysts describes those catalysts that contain aluminum, i.e., aluminum-containing catalysts. Use of these aluminum-based catalysts enables production of polyether polyols having very low unsaturation as compared to similarly sized polyether polyols produced using typical basic metal catalysts. In addition, polyether polyols formed via catalysis with these aluminum-based catalysts have properties that are the same or better than those produced using the typical basic metal catalysts and DMC catalysts. The aluminum-based catalysts can be synthesized in a very straightforward manner and are inexpensive compared to the other catalysts capable of producing these very low unsaturation polyether polyols. It has also been found that these aluminum-based catalysts do not have to be removed after formation of the polyether polyol prior to its use in forming, i.e., producing, a polyurethane product. The polyurethane product can be foamed or non-foamed, i.e., elastomeric, and is described additionally below. Unlike the DMC class of catalysts, the aluminum-based catalysts used in the present invention exhibit no induction period and are capable of polyoxyalkylation utilizing ethylene oxide. The various aluminum-based catalysts suitable for use in the process of the present invention are described additionally below.

The method includes the step of introducing an initial starter/catalyst mixture into the reactor (step (a)). The initial starter/catalyst mixture comprises an initial starter and a catalyst, specifically the aluminum-based catalysts originally introduced above and described additionally below. The initial starter can include a simple, initiator molecule or, in the alternative, an oligomeric starter, or a combination of the two. As understood by those skilled in the art, suitable initiator molecules have at least one alkylene oxide reactive hydrogen, with more preferred initiator molecules having at least two alkylene oxide reactive hydrogens.

If the initial starter in the mixture is the initiator molecule, then the initiator molecule preferably comprises an alcohol, a polyhydroxyl compound, a mixed hydroxyl and amine compound, an amine, a polyamine compound, or mixtures of these initiator molecules. Other initiator molecules may be suitable. Examples of suitable alcohols include, but are not limited to, aliphatic and aromatic alcohols, such as lauryl alcohol, nonylphenol, octylphenol and C₁₂ to C₁₈ fatty alcohols. Examples of suitable polyhydroxyl compounds include, but are not limited to, diols, triols, and higher functional alcohols such as sucrose and sorbitol. Examples of suitable amines include, but are not limited to, aniline, dibutylamine, and C₁₂ to C₁₈ fatty amines. Examples of suitable polyamine compounds include, but are not limited to, diamines such as ethylene diamine and toluene diarnine.

Where the initial starter in the mixture is the oligomeric starter, the oligomeric starter comprises the reaction product of an initiator molecule, such as those described above, and at least one alkylene oxide. More specifically, to form an appropriate oligomeric starter, the initiator molecule is oligomerized, i.e., modified, under catalysis with the at least one alkylene oxide to increase its equivalent weight, specifically its equivalent weight to from 100 to 500 Daltons. Suitable alkylene oxides for modification of the initiator molecule to form the oligomeric starter include, but are not limited to, ethylene oxide, propylene oxide, butylene oxide, epichlorohydrin or mixtures of these alkylene oxides. Once formed, the oligomeric starter is used as the initial starter along with the aluminum-based catalyst to make up the initial starter/catalyst mixture.

The catalyst is, more specifically, selected from aluminum phosphate catalysts and/or aluminum phosphonate catalysts and/or residues of the aluminum phosphate catalysts and aluminum phosphonate catalysts. The aluminum phosphate catalysts and aluminum phosphonate catalysts include in their description carboxy-modified aluminum phosphate catalysts and carboxy-modified aluminum phosphonate catalysts, respectively. The aluminum phosphate catalysts and aluminum phosphonate catalysts, including the carboxy-modified aluminum-based catalysts, and their residues are collectively referred to throughout this description as the aluminum-based catalysts. Without intending to be bound by theory, the aluminum-based catalysts may undergo exchange reactions to some extent with the initial starter in a reversible manner to form a modified aluminum phosphate or a modified aluminum phosphonate, which is also catalytically active. These modified aluminum phosphates and phosphonates are also referred to as residues.

Generally, the aluminum-based catalysts are utilized in an amount of from 0.1 to 5.0 weight percent based on the total weight of the polyether polyol, more preferably at levels of from 0.25 to 0.75 weight percent on the same basis. Certain of the aluminum-based catalysts utilized in the process of the present invention may be water sensitive, e.g. aluminum phosphate catalysts. As such, although not required, it is preferable that water levels of all components used in formation of the polyether polyol be at or below 0.1 weight percent of the particular component, more preferably at or below 0.05 weight percent.

Where the catalyst is the aluminum phosphate catalyst, it is preferred that the aluminum phosphate catalyst have the general structure of P(O)(OAlR′R″)₃ wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group. Examples of suitable haloalkyl groups include, but are not limited to, chloromethyl groups and trifluoromethyl groups. In preferred embodiments of the present invention for the aluminum phosphate catalysts, R′ and R″ independently comprise one of an ethyl group, an ethoxy group, a propyl group, a propoxy group, a butyl group, a butoxy group, a phenyl group, or a phenoxy group.

The aluminum phosphate catalysts used in the process of the present invention can be produced by a number of processes, one of which is described in detail below in the Examples. Others are described in the Examples of United States Patent Application Publication No. 2005 0234209, the disclosure of which is hereby incorporated by reference in its entirety. In general, the procedure involves reacting phosphoric acid and a tri-substituted aluminum compound to produce the aluminum phosphate catalyst. As is known, the phosphoric acid has the structure of PO(OH)₃, wherein: P represents a pentavalent phosphorous; O represents oxygen; and H represents hydrogen. The tri-substituted aluminum compounds have the general structure of AIR′₃, wherein: R′ is a methyl group, an alkyl group, an alkoxy group, an aryl group, or an aryloxy group. Some examples include, but are not limited to, trimethylaluminum, triethylaluminum, triethoxyaluminum, tri-n-propylaluminum, tri-n-piopoxyaluminum, tri-iso-propoxyaluminum, tri-iso-butylaluminum, tri-sec-butylaluminum, tri-iso-butoxyalminum, tri-sec-butoxyaluminum, tri-tert-butoxyaluminum, triphenylaluminum, and tri-phenoxyaluminum.

As noted above, the aluminum phosphate catalyst may be a carboxy-modified aluminum phosphate catalyst. In this case, the carboxy-modified aluminum phosphate catalyst has the general structure of P(O)(OAlR′R″)₃ wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group, so long as at least one of R′ and R″ is a carboxy group. Where the carboxy-modified aluminum phosphate catalyst is used, it is possible for R′ and R″ to, more specifically, comprise one of an ethyl group, an ethoxy group, a propyl group, a propoxy group, a butyl group, a butoxy group, a phenyl group, or a phenoxy group, so long as one of R′ and R″ is the carboxy group. The carboxy group may also be referred to in the art as a carboxylate group. Further, as known to those skilled in the art, a carboxy, or carboxylate, group is a radical or moiety chemically represented as —COO⁻. One preferred carboxy-modified aluminum phosphate catalyst comprises a tris[bis(carboxy)aluminum]phosphate catalyst. Examples of suitable tris[bis(carboxy)aluminum]phosphate catalysts include, but are not limited to, those selected from the group of tris(diacetoxyaluminum) phosphate, tris(dibenzoyloxyaluminum)phosphate, tris[bis(chloroacetoxy)aluminum]phosphate, tris[bis(dichloroacetoxy)aluminum]phosphate, tris[bis(trichloroacetoxy)aluminum]phosphate, tris[bis(trifluoroacetoxy)aluminum]phosphate, and mixtures thereof. As can be derived from the above examples, it is common for the carboxy group of the catalyst to comprise acetate, trifluoracetate, or dichloroacetate.

The carboxy-modified aluminum phosphate catalysts used in the process of the present invention can be produced by a number of processes. In general, the procedure involves reacting phosphoric acid and one or more of the tri-substituted aluminum compounds described above. This reaction produces the aluminum phosphate catalyst. Once the aluminum phosphate catalyst is produced, a solution of a carboxylic acid, such as acetic acid, dichloroacetic acid, or trifluoracetic acid, is introduced and added to the aluminum phosphate catalyst to produce the carboxy-modified aluminum phosphate catalyst.

Where the catalyst is the aluminum phosphonate catalyst, it is preferred that the aluminum phosphonate catalyst have the general structure of RP(O)(OAlR′R″)₂ wherein: O represents oxygen; P represents pentavalent phosphorous; Al represents aluminum; R comprises hydrogen, an alkyl group, or an aryl group; and R′ and R″ independently comprise a halide, an alkyl group, a haloalkyl group, an alkoxy group, an aryl group, an aryloxy group, or a carboxy group. Examples of suitable haloalkyl groups are the same as those already described above. In preferred embodiments of the present invention for the aluminum phosphonate catalysts, R′ and R″ independently comprise one of an ethyl group, an ethoxy group, a propyl group, a propoxy group, a butyl group, a butoxy group, a phenyl group, or a phenoxy group.

The aluminum phosphonate catalysts used in the process of the present invention can be produced by a number of processes, examples of which are described in detail in U.S. Pat. Nos. 6,706,844; 6,777,533; and 6,919,486 and also in the Examples of United States Patent Application Publication No. 2005 0250867, the disclosures of which are all hereby incorporated by reference in their entirety. In general, the procedure involves reacting a pentavalent phosphonic acid and a tri-substituted aluminum compound to produce the aluminum phosphonate catalyst. As is known, the pentavalent phosphonic acids that are suitable have the general structure of RPO(OH)₂, wherein: R represents hydrogen, an alkyl group, or an aryl group; P represents a pentavalent phosphorous; O represents oxygen; and H represents hydrogen. Some examples include phosphonic acid, methylphosphonic acid, ethylphosphonic acid, propylphosphonic acid, iso-, tert-, or sec- butylphosphonic acids, and phenylphosphonic acid. The tri-substituted aluminum compounds are the same as those described above in the context of the aluminum phosphate catalysts.

As noted above, the aluminum phosphonate catalyst may be a carboxy-modified aluminum phosphonate catalyst. In this case, the carboxy-modified aluminum phosphonate catalyst has the general structure of RP(O)(OAlR′R″)₂ wherein: O represents oxygen; P represents pentavalent phosphorous; Al represents aluminum; R comprises hydrogen, an alkyl group, or an aryl group; and R′ and R″ independently comprise a halide, an alkyl group, a haloalkyl group, an alkoxy group, an aryl group, an aryloxy group, or a carboxy group, so long as at least one of R′ and R″ is a carboxy group. Where the carboxy-modified aluminum phosphonate catalyst is used, it is possible for R′ and R″ to, more specifically, comprise one of an ethyl group, an ethoxy group, a propyl group, a propoxy group, a butyl group, a butoxy group, a phenyl group, or a phenoxy group, so long as one of R′ and R″ is the carboxy group. One preferred carboxy-modified aluminum phosphonate catalyst comprises a bis[bis(carboxy)aluminum]phosphonate catalyst. Examples of suitable bis[bis(carboxy)aluminum]phosphonate catalysts include, but are not limited to, those selected from the group of bis(diacetoxyaluminum)methylphosphonate, bis(dibenzoyloxyaluminum)methylphosphonate, bis[bis(chloroacetoxy)aluminum]methylphosphonate, bis[bis(dichloroacetoxy)aluminum]methylphosphonate, bis[bis(trichloroacetoxy)aluminum]methylphosphonate, bis[bis(trifluoroacetoxy)aluminum]methylphosphonate, bis(diacetoxyaluminum)phenylphosphonate, bis(dibenzoyloxyaluminum) phenylphosphonate, bis[bis(chloroacetoxy)aluminum]phenylphosphonate, bis[bis(dichloroacetoxy)aluminum]phenylphosphonate, bis[bis(trichloroacetoxy)aluminum]phenylphosphonate, bis[bis(trifluoroacetoxy)aluminum]phenylphosphonate, and mixtures thereof. As can be derived from the above examples, it is common for the carboxy group of the catalyst to comprise acetate, trifluoracetate, or dichloroacetate.

The carboxy-modified aluminum phosphonate catalysts used in the process of the present invention can be produced by a number of processes. In general, the procedure involves reacting a pentavalent phosphonic acid with one or more of the tri-substituted aluminum compounds described above. This reaction produces the aluminum phosphonate catalyst. Once the aluminum phosphonate catalyst is produced, a solution of a carboxylic acid, such as acetic acid, dichloroacetic acid, or trifluoracetic acid, is introduced and added to the aluminum phosphonate catalyst to produce the carboxy-modified aluminum phosphonate catalyst.

The aluminum phosphate catalysts and aluminum phosphonate catalysts, including the carboxy-modified aluminum-based catalysts, described above are additionally described in co-pending patent applications U.S. Ser. No. 10/832,910 (filed on Apr. 27, 2004); Ser. Nos. 11/151,077, 11/151,617, and 11/151,618 (all three filed on Jun. 13, 2005), the disclosures of which are herein incorporated by reference in their entirety.

The process according to the present invention further includes the step of continuously introducing one or more alkylene oxide into the reactor (step (b)). Suitable alkylene oxides include, but are not limited to, ethylene oxide, propylene oxide, butylene oxide, epichlorohydrin or mixtures of these alkylene oxides. As is known, alkylene oxides are used to polyoxyalkylate the initial starter described above to form polyether polyols.

Additional amounts of the catalyst described above are continuously introduced into the reactor (step (c)), and a continuous starter is continuously introduced into the reactor (step (d)). The continuous starter may be the same as the initial started described above or may be different. Suitable continuous starters include, but are not limited to, water, ethylene glycol, diethylene glycol, triethylene glycol, propylene glycol, dipropylene glycol, tripropylene glycol, 1,2-, 1,3-, and 1,4-butylene glycols, neopentyl glycol, glycerine, trimethylolpropane, triethylolpropane, pentaerythritol, α-methylglucoside, hydroxy-methyl-, hydroxyethyl-, and hydroxypropylglucosides, sorbitol, mannitol, sucrose, tetrakis [2-hydroxyethyl and 2-hydroxypropyl]ethylene diamines, and other commonly used continuous starters. Also suitable are monofunctional starters such as methanol, ethanol, 1-propanol, 2-propanol, n-butanol, 2-butanol, 2-ethylhexanol, and the like, as well as phenol, catechol, 4,4′-dihydroxybiphenyl, 4,4′-dihydroxydiphenylmethane, etc. The continuous starter may be essentially any polyoxyalkylene polymer or copolymer (including, for example, oligomerized glycerin and/or oligomerized glycols) or suitable initiator for the production thereof, which has an equivalent weight less than the desired product equivalent weight. Thus, the equivalent weight of the continuous starter may vary between 9 Daltons (water) and 15,000 Daltons (high equivalent weight polyoxyalkylene polyol). It is preferred to use continuous starters with an equivalent weight less than 1000 Daltons, preferably less than 500 Daltons, and most preferably less than 300 Daltons.

Although not required, it is most preferred that the one or more alkylene oxide continuously introduced in step (b), the additional amounts of the catalyst continuously introduced in step (c), and the continuous starter continuously introduced in step (d) are each continuously introduced into the reactor via independent feed streams.

The term ‘continuously’ as used herein in reference to steps (b)-(d), may be defined as a mode of addition of the catalyst and/or relevant reactant (the alkylene oxide and/or the continuous starter) in such manner so as to maintain an effective concentration of the catalyst and/or reactant substantially continuously. For example, the introduction, or feeding, of the catalyst and/or particular reactant may be truly continuous or may be in relatively closely spaced increments. It would not detract from the present continuous process to incrementally add a catalyst and/or reactant in such a manner that the concentration of the added catalyst and/or reactant decreases to essentially zero for some time prior to the next incremental addition. However, it is preferred that the concentration of the catalyst and/or reactant be maintained at substantially the same level during the majority of the course of the continuous process, and that low equivalent weight starter be present during the majority of the process. Incremental addition of the catalyst and/or reactant which does not substantially affect the nature of the polyether polyol is still ‘continuous’ as that term is used herein. It is feasible, for example, to provide a recycle loop where a portion of the reacting mixture is back fed to a prior point in the process, thus smoothing out any discontinuities brought about by incremental additions.

As a result of steps (a)-(d), the alkylene oxide reacts with the initial starter and the polyether polyol is prepared. More specifically, continuous oxyalkylation progresses as steps (b)-(d) occur and the polyether polyol prepared according to this process can be continuously withdrawn from the reactor. As the polyether polyol is formed and withdrawn, there is no need to remove, by neutralization and filtration or any other mechanism, the aluminum-based catalysts or any of their residues from the polyether polyol prior to use of the polyether polyol in forming polyurethane products. Although there is no need to remove the aluminum-based catalysts or any of their residues, the polyether polyol can be worked-up, i.e., purified, as desired.

Preferably, the residence time for reaction of the initial starter and the alkylene oxide or oxides in the presence of the aluminum-based catalyst or catalysts is for a period of time from 15 minutes to 15 hours. Typically, this period of time is sufficient to form polyether polyols having an equivalent weight of from 100 to 10,000, more preferably 200 to 3,000, and most preferably from 500 to 2,000, Daltons. The reaction between the initiator molecule and the alkylene oxide is generally conducted at a temperature of from 95° C. to 150° C., and more preferably at a temperature of from 105° C. to 130° C. A preferred process for continuously preparing a polyether polyol according to the subject invention has been described herein and is further described below in the Examples. However, it is to be understood that additional continuous processes for preparing polyether polyols in the general context of the present invention and within the bounds of the present invention may also be used. Such additional continuous processes are generally described in U.S. Pat. No. 5,689,012 to Pazos et al., the disclosure of which is hereby incorporated by reference in its entirety. Of course, with the additional continuous processes disclosed in the '012 patent to Pazos et al., an aluminum-based catalyst would be utilized in lieu of the DMC catalysts used in the '012 patent.

The polyether polyols formed via the continuous process of the present invention have very low unsaturation. More specifically, the polyether polyols formed according to the present invention typically have an unsaturation of less than or equal to 0.020 meq KOH/g, more preferably less than or equal to 0.015 meq KOH/g, and most preferably less than or, equal to 0.010 meq KOH/g. Furthermore, as described above, the polyether polyols formed according to the present invention typically have an equivalent weight of from 100 to 10,000, more preferably 200 to 3,000, and most preferably from 500 to 2,000, Daltons. The polyether polyols formed according to the continuous process of the present invention include, after formation of the polyether polyol, the aluminum-based catalyst or residue thereof. That is, the polyether polyol can comprise the aluminum-based catalyst or residue thereof. If so, the aluminum-based catalyst is preferably present in an amount of from 0.1 to 5.0 weight percent based on the total weight of the polyether polyol. As alluded to above, the aluminum-based catalyst or its residue can even remain in the polyether polyol as the polyether polyol is used to make polyurethane products. There is no need to remove, by neutralization and/or filtration, the aluminum-based catalyst or any of its residues from the polyether polyol prior to use of the polyether polyol to form polyurethane products. Remaining amounts of the aluminum-based catalyst in the polyether polyol and, ultimately, in the final polyurethane product do not negatively impact the desired properties in the final polyurethane product. Optionally, although not required, it is to be understood that the remaining amounts of the aluminum-based catalyst can be removed by methods known and understood by those skilled in the art as desired.

As described immediately below, the polyether polyol is used in conjunction with a cross-linking agent, such as an organic isocyanate (including an organic polyisocyanates) and/or an isocyanate pie-polymer, to produce the polyurethane product. The polyether polyol has reactive hydrogens. It is to be understood that the polyether polyol can be included in a polyol component having at least one of the polyether polyols and, preferably, including a blend of more than one polyether polyol.

The polyurethane product is formed by reacting at least one organic isocyanate and/or isocyanate pre-polymer, i.e., cross-linking agent, with the polyether polyol. More specifically, the organic isocyanate and/or isocyanate pre-polymer have functional groups that are reactive to the reactive hydrogens of the polyether polyol. Suitable organic isocyanates include, but are not limited to, diphenylmethane diisocyanate (MDI), toluene diisocyanate (TDI), polymeric diphenylmethane diisocyanate (PMDI), and mixtures thereof.

In addition to the polyether polyol, other additional substances having reactive hydrogens may also participate in the reaction. Examples of such additional substances include, but are not limited to, amines and chain extenders, such as diols and triols. The polyether polyol and the organic isocyanate and/or isocyanate pre-polymer may, optionally, be reacted in the presence of a urethane promoting catalyst and certain additives including, but not limited to, blowing agents (if the polyurethane product is foamed rather than merely a polyurethane elastomer product), cross-inkers, surfactants, flame retardants, fillers, pigments, antioxidants, and stabilizers. The urethane promoting catalyst is different than the aluminum-based catalyst used in the continuous process of the present invention. The polyurethane products formed with the polyether polyol produced according to the process of the present invention include flexible foams, semi-rigid foams, rigid foams, coatings, and elastomers such as adhesives, sealants, thermoplastics, and combination thereof.

As alluded to above, the aluminum-based catalyst or its residue can remain in the polyether polyol as the polyether polyol is used to make polyurethane products. In other words, there is no need to remove, by neutralization and/or filtration, the aluminum-based catalyst or any of its residues from the polyether polyol prior to use of the polyether polyol to form polyurethane products. As such, in one embodiment of the present invention, the polyurethane product comprises greater than 0.001, more preferably from 0.001 to 5.0, weight percent of aluminum-based catalyst and/or aluminum-based catalyst residues based on the total weight of the polyurethane product.

### EXAMPLES

The following Examples illustrate the nature of the subject process invention with regard to the continuous synthesis or preparation of polyether polyols using aluminum-based catalysts. The Examples presented herein are intended to illustrate, and not to limit, the subject invention.

### Example 1

### Synthesis of Aluminum Phosphate Catalyst, Specifically Tris(di-sec-butoxyaluminum) Phosphate

To produce, for example, Tris(di-sec-butoxyaluminum) phosphate as an aluminum phosphate catalyst, the procedure more specifically includes placing a solution of 147.6 g (0.6 mole) of aluminum tri-sec-butoxide in 600 ml of dry THF in a 3 L round bottom flask equipped with mechanical stirring and a nitrogen atmosphere. The solution is cooled to 0° C. in a dry ice/isopropanol mixture. A solution of 17.0 g (0.2 mole) of polyphosphoric acid in 400 ml of isopropyl alcohol cooled to 0° C. is prepared by stirring magnetically in a nitrogen atmosphere. The solution is rapidly added to the flask thereby creating a clear, pink solution. After stirring 0.5 hr., the solution is allowed to warm to room temperature and stand overnight. The reaction mixture is then concentrated under vacuum, diluted with 500 mL of toluene, and further concentrated to a slightly viscous clear solution weighing 307.3 g, which represents ˜30% of the aluminum phosphate catalyst in toluene.

### Example 2

### Continuous Process for Preparing Polyether Polyol in CSTR

A 10-gallon continuous stirred tank reactor is charged with 9 gallons of a 29 hydroxyl number propoxylate of glycerin made in a batch reactor using 0.5% of the tris(di-sec-butoxyaluminum) phosphate from Example 1 as the catalyst. The reactor contents are heated to 110° C. Feed begins of an initiator mixture comprising a 230 hydroxyl number propoxylate of glycerin and 0.5% of the tris(di-sec-butoxyaluminum) phosphate from Example 1 as the catalyst. The feed rate is 380 g/hr. At the same time, the feed of propylene oxide begins at a rate of 2820 g/hr. Also at the same time, the discharge pump begins removing the reaction mixture at a rate of 3200 g/hr. The reaction mixture pumped from the reactor is stripped under vacuum to remove volatile impurities, including unreacted propylene oxide. The purified polyether polyol is a colorless liquid with an unsaturation value of 0.008 meq/g KOH and a hydroxyl number of 29, corresponding to an equivalent weight of 1930 Daltons.

### Example 3

### Continuous Process for Preparing Polyether Polyol in Tubular Reactor

A tubular reactor is employed which is 120 ft long, with an internal diameter of 1 inch. An outer tube is attached with an annulus of 1 inch. Heat transfer fluid is pumped through the annulus to maintain the 110° C. reaction temperature. At a point 100 ft from the start of the reactor tube, an injector port is provided downstream for injecting ethylene oxide into the reaction stream. Separate tanks and pumps are provided for the alkylene oxides, the initiator, and the catalyst. The reagents enter the reactor through a mixing chamber containing a static mixer.

The reactor is filled with a 25 hydroxyl number propoxylate of glycerin made in a batch reactor using 0.5% of the tris(di-sec-butoxyaluminum) phosphate from Example 1 as the catalyst. The initiator tank is filled with glycerin. The catalyst tank is filled with a 25% solution of the tris(di-sec-butoxyaluminum) phosphate from Example 1 in tetrahydrofuran. Polymerization begins by pumping simultaneously into the reactor glycerin at 46 g/hr, catalyst solution at 67 g/hr, and propylene oxide at 2820 g/hr. Ethylene oxide is injected into the downstream port at a rate of 505 g/hr. The reaction mixture pumped from the reactor is stripped under vacuum to remove volatile impurities, including unreacted propylene and ethylene oxides. The purified polyether polyol is a colorless liquid with an unsaturation value of 0.008 meq/g KOH and a hydroxyl number of 25, corresponding to an equivalent weight of 2200 Daltons. The polyol contains an end block of 15% ethylene oxide.

The invention has been described in an illustrative manner, and it is to be understood that the terminology which has been used is intended to be in the nature of words of description rather than of limitation. Obviously, many modifications and variations of the present invention are possible in view of the above teachings. It is, therefore, to be understood that within the scope of the claims the invention may be practiced otherwise than as specifically described.

What is claimed is:

1. A continuous process for preparation of a polyether polyol in a reactor, said process comprising the steps of:
(a) introducing an initial starter/catalyst mixture into the reactor, the initial starter/catalyst mixture comprising an initial starter and a catalyst selected from aluminum phosphate catalysts and/or aluminum phosphonate catalysts and/or residues of the aluminum phosphate catalysts and aluminum phosphonate catalysts;
(b) continuously introducing one or more alkylene oxide into the reactor;
(c) continuously introducing additional amounts of the catalyst into the reactor;
(d) continuously introducing a continuous starter into the reactor, wherein the continuous starter and the initial starter may be the same or different; and
e) continuously withdrawing the polyether polyol from the reactor.

2. A continuous process as set forth in claim 1 wherein the catalyst is an aluminum phosphate catalyst having the general structure of P(O)(OAlR′R″)₃ wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group.

3. A continuous process as set forth in claim 2 wherein R′ and R″ independently comprise one of an ethyl group, an ethoxy group, a propyl group, a propoxy group, a butyl group, a butoxy group, a phenyl group, or a phenoxy group.

4. A continuous process as set forth in claim 2 wherein the carboxy group comprises acetate, trifluoracetate, or dichloroacetate.

5. A continuous process as set forth in claim 2 wherein the aluminum phosphate catalyst comprises a carboxy-modified aluminum phosphate catalyst.

6. A continuous process as set forth in claim 5 wherein the carboxy-modified aluminum phosphate catalyst comprises a tris[bis(carboxy)aluminum]phosphate catalyst.

7. A continuous process as set forth in claim 6 wherein the tris[bis(carboxy)aluminum]phosphate catalyst is selected from the group of tris(diacetoxyaluminum)phosphate, tris(dibenzoyloxyaluminum)phosphate, tris[bis(chloroacetoxy)aluminum]phosphate, tris[bis(dichloroacetoxy)aluminum]phosphate, tris [bis(trichloroacetoxy)aluminum]phosphate, tris[bis(trifluoroacetoxy)aluminum]phosphate, and mixtures thereof.

8. A continuous process as set forth in claim 1 wherein the catalyst is an aluminum phosphonate catalyst having the general structure of RP(O)(OAlR′R″)₂ wherein: O represents oxygen; P represents pentavalent phosphorous; Al represents aluminum, R comprises hydrogen, an alkyl group, or an aryl group; and R′ and R″ independently comprise a halide, an alkyl group, a haloalkyl group, an alkoxy group, an aryl group, an aryloxy group, or a carboxy group.

9. A continuous process as set forth in claim 8 wherein R′ and R″ independently comprise one of an ethyl group, an ethoxy group, a propyl group, a propoxy group, a butyl group, a butoxy group, a phenyl group, or a phenoxy group.

10. A continuous process as set forth in claim 8 wherein the carboxy group comprises acetate, trifluoracetate, or dichloroacetate.

11. A continuous process as set forth in claim 8 wherein the aluminum phosphonate catalyst comprises a carboxy-modified aluminum phosphonate catalyst.

12. A continuous process as set forth in claim 11 wherein the carboxy-modified aluminum phosphonate catalyst comprises a bis[bis(carboxy)aluminum]phosphonate catalyst.

13. The method of claim 12 wherein the bis[bis(carboxy)aluminum]phosphonate catalyst is selected from the group of bis(diacetoxyaluminum)methylphosphonate, bis(dibenzoyloxyaluminum) methylphosphonate, bis[bis(chloroacetoxy)aluminum]methylphosphonate, bis[bis(dichloroacetoxy)aluminum]methylphosphonate, bis[bis(trichloroacetoxy)aluminum]methylphosphonate, bis[bis(trifluoroacetoxy)aluminum]methylphosphonate, bis(diacetoxyaluminum)phenylphosphonate, bis(dibenzoyloxyaluminum) phenylphosphonate, bis[bis(chloroacetoxy)aluminum]phenylphosphonate, bis[bis(dichloroacetoxy)aluminum]phenylphosphonate, bis[bis(trichloroacetoxy)aluminum]phenylphosphonate, bis[bis(trifluoroacetoxy)aluminum]phenylphosphonate, and mixtures thereof.

14. A continuous process as set forth in claim 1 wherein the initial starter comprises an initiator molecule.

15. A continuous process as set forth in claim 14 wherein the initiator molecule comprises an alcohol, a polyhydroxyl compound, a mixed hydroxyl and amine compound, an amine, a polyamine compound, or mixtures of these initiator molecules.

16. A continuous process as set forth in claim 1 wherein the initial starter comprises an oligomeric starter comprising the reaction product of an initiator molecule and at least one alkylene oxide.

17. A continuous process as set forth in claim 16 wherein the oligomeric starter has a number average molecular weight of from 200 to 1,500 Daltons.

18. A continuous process as set forth in claim 1 wherein the alkylene oxide comprises ethylene oxide, propylene oxide, butylene oxide, epichlorohydrin or mixtures of these alkylene oxides.

19. A continuous process as set forth in claim 1 wherein the reactor is a continuous reactor.

20. A continuous process as set forth in claim 19 wherein the continuous reactor is a tubular reactor.

21. A continuous process as set forth in claim 19 wherein the continuous reactor is a continuous stirred tank reactor.

22. A continuous process as set forth in claim 1 wherein the one or more alkylene oxide continuously introduced in step (b), the additional amounts of the catalyst continuously introduced in step (c), and the continuous starter continuously introduced in step (d) are each continuously introduced into the reactor via independent feed streams.

23. A continuous process as set forth in claim 1 wherein the catalyst is present in an amount of from 0.1 to 5.0 weight percent based on the total weight of the polyether polyol.

24. A continuous process as set forth in claim 1 wherein the polyether polyol prepared according to the continuous process has an unsaturation of less than or equal to 0.020 meq KOH/g.

25. A continuous process as set forth in claim 1 wherein the polyether polyol prepared according to the continuous process has an equivalent weight of from 100 to 10,000 Daltons.

26. A polyether polyol formed according to the process of claim 1.
